(19) United States
(12) Patent Application Publication
(10) Pub. No.: US 2013/0284340 A1
(43) Pub. Date: Oct. 31, 2013

(54) VULCANIZATION PROCESS OF RUBBER TIRES WITH THE USE OF MICROWAVES

(71) Applicant: Julia Takahashi, Dracena (BR)

(72) Inventor: Julia Takahashi, Dracena (BR)

(21) Appl. No.: 13/846,976

(22) Filed: Mar. 19, 2013

Related U.S. Application Data
(63) Continuation-in-part of application No. 12/513,968, filed on Nov. 30, 2009, now abandoned.

(51) Int. Cl. B29D 30/00

(52) U.S. Cl. CPC B29D 30/00
USPC 156/64

(57) ABSTRACT

Vulcanization process for a rubber tire with the use of microwave frequencies and the use of conductive materials in a pre-molded rubber using one or more layers of rubber formulations and determining the frequency parameters, vulcanization temperature and cure time by the type and quality of the elastomeric raw material.

### CROSS REFERENCE TO RELATED APPLICATION

This application is a continuation-in-part of U.S. patent application Ser. No. 12/513,968, filed Nov. 30, 2009, which is a 371 of International Application No. PCT/BR2007/000267 filed on May 14, 2007, the entire content and disclosure of each is incorporated herein by reference.

### FIELD OF THE INVENTION

The present invention is related to vulcanization processes for tires.

### BACKGROUND OF THE INVENTION

Elastomers used in tires are predominantly physical blends of natural rubber (NR) and butadiene-styrene copolymer (SBR) or NR and polybutadiene (BR). Among the most used we can mention: 1) SBR: SBR 1502, 1712, 1778; 2) (ethylene propylene diene M-class rubber) EPDM; characterized by presenting ultra-fast, fast and medium cure with varied viscosity; 3) CR: Neoprene W, WB, WHV; Baypren 210, 214; 4) NBR—all; 5) Silicon—all; and 6) Natural rubber—GEB, CCEti Smoked Sheet, FFB I.

Depending on the product application the elastomer type to be used is determined. However to get a good processing in the extrusion the product should present a flat surface and with good extrusion capacity, and in order to achieve it the formulator should consider some important characteristics as: gum viscosity; plasticizing degree; density and molecular structure; and necessary cure system.

After familiarizing with the rubber to be composed, the formulator will consider the systems of charges, plasticizers, protection, activation and vulcanization.

(A) The system of charges can be formed from charges of organic or mineral nature.

Organic Charges:

(1a) Carbon black: when a rubber compound is extruded through a matrix, it suffers a minimum incitation and subsequent shrinking. The shrinking in the extrusion is affected by the carbon black structure, particle size and charge level.

The high-structure carbon black produces low shrinking during the extrusion and the low-structure carbon black produces compounds with high shrinking during the extrusion.

Thus the compounds with high-structure carbon black produce extruded compounds with optimal dimensional stability. The choice of the type and amount of carbon black to be used in an extruded rubber compound is a decisive factor for the quality of the final product.

The influences of the carbon black type also vary in accordance with the elastomer type. In rubbers tending to crystallization, as CR-polychloroprene and NR-natural, fast alterations are observed in the properties with the addition of amounts of CB, differently from the more amorphous elastomers, as EPDM and SBR. The extruded carbon blacks that are mainly used are:

(a) N-683 or APE (all-purpose furnace)—considered as a semi-reinforcing carbon black, due its particle size but with excellent dispersion properties, due its high structure. It delivers to the product an excellent extrusion capacity and dimensional stability, allowing charging about 15% more than N-550 to reach similar results of hardness.
(b) N-550 or FEF (fast extrusion furnace)—considered as a semi-reinforcing carbon black, it has high structure and is broadly used in the composition of extruded articles.
(c) N-339 or HAF-HS (high abrasion furnace)—considered as a reinforcing carbon black, HAF has high structure besides small particle size. It should be used together with N-550 when increasing the tension, module and abrasion resistance properties in the rubber compound is desired. Due to its small particle size and high structure, the compounds produced with this type of CB have higher money viscosity (rigidity of the material before the vulcanization), also increasing the heat generation during the blend process and during the extrusion,
(2) Mineral charges: they are broadly used in the production of compounds to rubber extrusion, since they deliver some very important properties to the materials. Most of mineral charges reduce the cost of the compound; reduce the expansion factor and profile shrinking during the extrusion; stabilize the viscosity of the compound; reduce the increase of heat during the process of blend and extrusion; usually present fast incorporation, except to precipitated powdered silica; and have low volatile content, not provoking porosities.

### (3) White Charges:

(3a) Calcium carbonate: it can be of natural or precipitate type, broadly used as stuffing charge in rubber compounds for extrusion. It is compatible with most of elastomers, has low cost, but does not deliver to the extruded product any benefit of superficial finishing, and in some cases may compromise the appearance, if it does not present a very well controlled granulometry. It also presents differentiated abrasion properties during the blend and extrusion process delivering low wear to the extrusion and cut tools.
(3b) Natural kaolin: its main characteristic is its low cost. It may be added in great amounts, if the polymer is able to absorb it. Another important point is the compound viscosity, since even by adding a great amount of kaolin the compound is still very well extrudable, due to its interference in the hardness and viscosity being almost insignificant. If the kaolin presents a good granulometry, it may offer a surface with good finishing, with several advantages. This advantages include: high abrasion property, delivering wearing to rotors and bambury camera, extruding thread and case, matrix, cut tool; interference in the cure system, leading to the need of neutralization of its acidity; and moistness, causing porosity in the product.
(4) Other natural mineral charges.
(4a) Quartz: used as charge to silicon compounds. With high abrasion property and low reinforcement, compromises some material characteristics.
(4b) Diatomite: used as stuffing charge when it is desired to improve resistance properties. It can be used with charge of silicon compounds, and also presenting low cost.
(5) Special mineral charges:
(5a) Precipitated silica: it is only used when it is necessary to obtain physical properties with high rupture tension, low tearing module, and high rupture elongation. It is very used in the hose industry, and in articles of clear color. The main disadvantage is the great interference in the vulcanization system, provoking a fast air aging of the compounds, increasing the viscosity of the compound and making difficult the extrusion. It may cause porosity in the extruded article, due its high moisture content (in some cases up to 7% in weight).
(5b) Granulated precipitated silica: it presents the same characteristics of the powdered silica but with the advantage related to the weight and incorporation in the compound and does not present the trend to be suspended in the air.
(5c) Sodium aluminate silica: it may be used as stuffing charge with very low reinforcing property. In relation to precipitated silica it presents a small influence in the vulcanization process, and it is of easier processing, but with higher cost.
(5d) Treated kaolin: it may be hydrated, calcined or signaled. It delivers better physical characteristics to the compounds, keep on being abrasive and it is still very used in the wire and cable industry, by having insulating properties. The signaled ones deliver larger reinforcement property in some buyable types with precipitate silica.
(5e) Mistron steam: it presents an excellent quality for application in extruded products of clear color. It is fine and selected mineral talc, with very well controlled granulometry, good reinforcement characteristics to the rubber, and very good extrusion capacity and dispersion characteristics. It has as disadvantage its high cost and difficulty of being found.
(5f) Sillitin: it is a mineral compound formed by aluminum silicate (kaolinite) and quartz. Its crystalline structure delivers some particular characteristics related to the compounds that will be extruded. The crystalline structure of the quartz (natural silica) is amorphous corpuscular, it is to say, without defined shape—the structure of the kaolinite is lamellar. The final structure of the sillitin compound (Neuburg silica) is composed.

It may be defined that the sillitin structure is branched: between two kaolinite lamellar particles it presents a corpuscular rugous particle of silica. The sillitin is a natural mineral charge extracted from the Neuburg region in Germany. The obtaining and improvement process is particular and very low granulometries are reached, still keeping its natural crystalline structure, with the following advantages: high-speed incorporation to the blend, excellent dispersion properties; delivers excellent characteristics of extrusion and dimensional stability; high charge degree; low content of volatile materials, not presenting porosity in compounds vulcanized without pressure; and very high chemical resistance and aging resistance.

(B) Protection systems: broadly used for the production of articles that need good aging properties, weather and high temperature resistance, allied to special characteristics such as: resistance to oils (nitric rubber); abrasion resistance and general use (SBR); high elasticity and mechanical resistance (Natural); and resistance to grease, high adhesiveness (CR).

Use of antioxidants and anti-ionizing: the use will be necessary when the elastomer does not present as intrinsic properties such resistance characteristics. Rubbers as EPDM and silicon don't require the addition of such products, except when the specification is very rigorous, such as for use in high-pressure automotive hoses, for example. Table 1 presents a list of possible antioxidant or anti-ionizing elements.

| Chemical nature | Trade name | Function |
|---|---|---|
| TMQ | Angerite Rests D ® (Vanderbilt ®) | Heat stabilizer |
| (1,2-dihydro,2,2,4-trimethylquinollne) | Flectol H ® (Monsanto ®) | |
| | Naugard Q ® (Uniroyal ®) | |
| 44-thlo-bis-(64-butyl-m-cresol) | Santonox R ® - Monsanto ® | Heat stabilizer |
| Tetrakis | Irganox 1010 ® (Ciba Geigy ®) | Heat stabilizer |
| Imethylene(3,5-di-t-butyl-4- | | |
| hydroxyhydrocinnamate)]methana | | |
| 2-mercapto-benzimidezole | Vulcanox MB ® (Bayer ®) | Ant[oxidizing |
| | Vanox MTI ® (Vanderbilt ®) | |
| Zinc salt of mercapto-benzlmldazote | Vulcanox ZMB2 ® (Bayer ®) | Heat stabilizer |
| | Vanox Zfri ® (Vanderbilt ®) | |
| Blend of mercapto-benzimidazole | Permanax OHS ® (Flexsys ®) | Copper inhibitor |
| and bis-a-hydroxy-5-methy1-3-(1- | | |
| methyl-cyclohexyl)-phenyl]methane | | |
| N,N-bis-[3(3,5-til-t-botyl-4′- | Irganox MD 1024 ® (Ciba Gelgy ®) | Antioxiclizing |
| hydrophenyl)-proponyll-hydrazine | | |

(C) Plasticizers: they are a group of raw materials used in the production of compounds of extruded rubber. Particularly this product has a great importance, due its performance be directly related to the behavior of process of blend, extrusion, vulcanization and after-vulcanization. It should be highlighted it is necessary to observe the great compatibility differences between rubbers and plasticizers, as for example:
(1) EPDM—paraffinic-naphtenic plasticizer.
(2) SBR—aromatic and paraffinic plasticizer.
(3) CR—aromatic plasticizer, DOP, polymeric.
(4) Natural—aromatic and paraffinic plasticizer.
(5) NBR—polymeric plasticizer, DOP, DOS, aromatic.
(6) Silicone—only silicone oil.

The quantity of plasticizer that can be incorporated in a compound is limited by the quantity of carbon black and clear charges and by the own characteristics of the polymer. For each vulcanization process after extrusion it should be observed the vulcanization temperatures and define a plasticizer type that has as minimum flash point the value of 20° C. above the cure temperature.

(D) Acceleration systems: this are developed to obtain certain characteristics such as: process safety during the extrusion or to support the extrusion process without beginning pre-vulcanization or reaction, a very common problem in extruded articles production; provide a not very long time and not very high vulcanization temperature at the beginning of vulcanization process to not collapse the profile; and provide a short final time of vulcanization to reach high speeds of vulcanization and do not migrate to the piece surface.
(D1) Accelerators classification: from the point of view of vulcanization speed, the accelerators are classified as:

### (1) Slow: DPG, DOTG,

### (2) Fast: TETD, TMTD, TMTM.

(3) Very fast: ZMDC, ZEDC, ABDC.
(4) Ultra-fast: dithiocarbamates of Se, Pb, Cu, Te, Cd, Bi
(5) Fast with delayed action: sulfenamides.

It should be observed that to reach a balanced vulcanization it is imperative to reach a synergic effect among the accelerators, to classify them as primary and secondary. To each rubber type a characteristic acceleration is developed, where in particular the sponges need more reinforced systems of acceleration, due to the interference of the high amounts of added plasticizers.

(E) Sponging agents: these are products that, when reaching a certain temperature, start a decomposition process, resulting in the formation of gases (nitrogen or byproducts). Each sponging agent has a characteristic temperature, speed and quantity of gases. In the production of extruded sponged products, the artifact is vulcanized with hot air, salt bath and UHF, and the used sponging agent should be combined with the system and vulcanization times, since it can not decompose before nor after the vulcanization, but during the vulcanization. The cell size depends directly on the size of the sponging particle.

Recapping of diagonal tires: it has started in Brazil in the 1950s, being practiced through molds in press. This recapping model was improved in the 1960s, with the development of presses with 3-parts frontal opening, having as function to reach the recapping and resoling. During this period, a process with exclusive function of providing resoling was developed, using a mold in a ring shape. These recapping and resoling processes were broadly used up to middle of 1980s, when the “radial tire” appeared in the automobile market.

Recapping of radial tires: this type of tire, by presenting a totally differentiated structure from the diagonal tires, demanded the development of alternative processes of recapping, technically called “vulcanization processes”.

Vulcanization process: it consists on the application of heat and pressure to a rubber compound, formed by double links along the molecular chain that technically can be translated by the change of the chemical structure of an elastomeric compound. This change happens in the crossed links among the chains, transforming what was an entangled of separate chains in a three-dimensional unified net. In this process the plasticity of the compound proportionally decreases to the increase of this net of crossed links, at the same time that increases the elasticity. In practice, the recovery of a deformation is never perfect, always having a residual plasticity in a vulcanized rubber, which is called “permanent deformation”.

In old times, the vulcanization consisted of mixing sulfur to the rubber with application of heat, to reach the crossed links among the molecule chains. However this procedure demanded a very long time. To minimize this inconvenience the vulcanization process has changed to the introduction of sulfur, and additionally of accelerating and activator elements, that aid in the reduction of the reaction time.

Vulcanization in synthetic rubbers: by being saturated these rubbers are characterized by not having chains with double links, and therefore cannot be vulcanized only with sulfur. In these cases, more reactive chemical products are used, such as peroxides, to reach the crosses links necessary to the correct vulcanization process.

Parameters considered in the vulcanization: the determination of the method and vulcanization conditions, such as: time, temperature and pressure; should take into account the type of employed composition (natural rubber or synthetic rubber), as well as the dimensions of the artifact to be produced. It should also consider the end of the product, where this definition determines the properties of the obtained final product.

Artifact to be produced: this determination is more critical for the artifacts of thick walls, since to obtain an adequate vulcanization in its interior, sometimes an over-vulcanization occurs in the surfaces. In general, as a resource to minimize this problem, it is used lower temperatures and longer times.

Elements used for obtaining the artifact: to obtain a recapped it is imperative the use of the following items:

(a) Camelback: it is a rubber profile with a link film between the tread and the carcass, being this tread still in the plastic state without vulcanization, and will receive pressing in molds that made the desired drawing for the customers application.
(b) Premolded: it is a molded rubber profile with a shape according to the needs of the user's application, which is already vulcanized and is applied with a link film to anchor this tread to the carcass.

### Physical Structure of the Pre-Molded Rubber

By examining the profile, it can be seen that the pre-molded rubber is comprised of two parts:
1—base—located on the adhering surface of the material with the linking rubber and the tire and ending in the bottom of the profile.
2—profile—begins in the final bottom of the profile and ends on the face that contacts the ground.

### Functions of the Structure:

1—base:
A structure designed to support loads applied on the profile as well as through its thickness in order to act as a reinforcement to protect the carcass plies when its use makes it possible to develop punctures and damages in the structures of the profile.
2—profile.

Developed to support such applications as, for example, asphalt, soil, etc, and climatic conditions such as snow, rain, etc: operation of the vehicle, such as steering axles with smooth or traction tires like rubbery tires.

### Chemical Structure of the Pre-Molded Rubber

It may be formulated as one or more layers according to the climatic needs of an application, operation or climatic conditions, or operation of the vehicle.

For economic reasons, differentiated materials may be created based on cost efficiency. For cost reasons, they are usually comprised of only one layer.

Such differentiated materials may be applied either to the base or the area of the tire profile, for example, aiming at increasing the mileage in traction tires, resistance to punctures, adherence to the snow, wear and puncture resistance in rocky and extremely rough terrains; military applications in hard to access terrains and/or resistance to aggressive climatic conditions, and the like.

Vulcanization Equipment Consistent with Materials Applied to the Tire.

Tire with application of camelback—mechanical pressing systems having varied closing systems are usually applied, some of which are axial or sectorial such as variations in the division of sectors such as 3 parts, 6 parts, 8 parts, 12 parts, as well as inflating systems varying in the use of the air tube, which is most conventional, as well as automated bag-o-matic systems that simulate the functions of the air tube with a more automated process; since the material requires vulcanization, the presses are usually provided with molds the function of which is to conform the material to the profile thereof during the vulcanization process.

Tires with application of pre-molded rubber—autoclaves are usually used for the vulcanization of tires, the main function of which is to vulcanize the linking rubber that joins the tire to the already vulcanized pre-molded rubber having the profile applied thereto.

### Tire Vulcanization Process in an Autoclave

It is a pressure chamber where the tires are installed, the function of which is to fix the pre-molded rubber to the tire using controlled pressure, temperature and time through electric or electronic systems that are programmed or not wherein such variations are stored with quite a great precision.

### Purpose of Applying Pressure in the Autoclave

The pressure is used in the process for compressing the pre-molded rubber on the tire in order to enhance the adhesion of both components to be joined by the linking rubber, which will then turn from the plastic state into the elastic state by means of heat and affix the new material to the tire.

### How Pressure is Applied to Tires:

To apply pressure in order to vulcanize the pre-molded rubber two main factors should be considered:

1—assembly of the tire before it is installed in an autoclave exhibiting three distinct assembly modes.
2—installation of the tires in the autoclave and its operation.

These two elements are very important since the success of the pressure application of pressure on the material to be vulcanized depends on joining same.

1—Assembly of the tire—

### Envelope:

It is a rubber housing the function of which is to involve the whole outer portion of the tire as well as insulate the tire from the direct pressure inside the autoclave, thus sealing the outer face of the tire with the pre-molded rubber applied thereto against the direct contact with the pressurized air coming from the autoclave, and this airtight atmosphere in the envelope is coupled by the nipple of the envelope through a hose to the atmosphere out of the autoclave, thus creating a differential pressure between the pressurized atmosphere inside the autoclave that is larger than the atmosphere inside the envelope; therefore all pressure is exerted outside the envelope; thus molding said housing to the profile of the tire.

This pressure exerted thereon compresses the pre-molded rubber and the linking rubber applied to the tire that will be subjected to vulcanization.

The envelope is applied to the tire in a previous assembly before its installation inside the autoclave, and it is sealed by ancillary components that make out an assembly that insulates the tire from the atmosphere inside the autoclave.

### Several Ways of Assembling the Envelope:

During the assembly, components that are associated to the envelope to complement the assembly and seal the envelope to the tire are used. Basically, there are 3 assembly systems:

1—wheel—with the envelope already applied to the tire, in this type of assembly an air tube as well as an air tube cover are applied inside the tire and then a wheel is placed thereon, the edges of the wheel contacting the edges of the envelope; the inflation of the air tube compressing the edge of the envelope against the edges of the wheel in the contact area, thus sealing the envelope that is coupled by the hose to the nipple of the envelope; usually a higher pressure is applied to the air tube installed in the tire than the inner pressure of the autoclave so that the wheel exerts the required pressure on the assembly and keeps the sealing: in this in case the autoclave is provided with a hose inside same that will couple the nipple at the inlet of the air tube that will convey the compressed air to the chamber.
2—sealing ring: with the envelope already applied to the tire, a metallic rim is applied to each one of the tire beads, the function of which is to compress the edges of the envelope against the bead, thus sealing the envelope that is coupled by the hose to the nipple of the envelope. It differs from the previous art since it does not require the assembly of air tube and its cover and the pressure of the envelope is only applied to the outer faces of the carcass, therefore, the interior of the tire where the air tube is applied is not provided with any housing that receives pressure and temperature directly from the interior of the autoclave.
3—inner envelope or innerlop—with the envelope already applied, another envelope called innerlop is applied inside the tire instead of the air tube used in the wheel system; at the edges of said envelope there is a rubber sealing system that joins the outer envelope to the innerlop, thus making it possible to apply the same pressure that is applied to the outer envelope inside the tire, the pressure of the autoclave compressing the edges of the outer envelope against the edges of the inner envelope and sealing same, turning all the faces of the tire into only one pressure atmosphere that will be connected to the outer atmosphere of the autoclave by the hose coupled to the nipple of the envelope; while it is assembled, vacuum is applied to the interior of the envelope through the air outlet of the envelope in order to keep same compressed against the tire and prevent possible misalignments and leaks, acting as an ancillary element for affixing the envelope to the tire before it is installed in the autoclave to be vulcanized.

### Application of Vacuum to the Tire:

It is quite clear that the main element for affixing the pre-molded rubber to the carcass during the linking rubber vulcanization process is the application of pressure to compress the new tread against the tire and assure that the two elements are joined together.

Some vulcanization systems use vacuum as an ancillary element in the assembly process or vulcanization, usually using a vacuum pump or venture that are both provided with a vacuum meter to check for possible leaks through the pressure level.

### Main Functions of the Use of Vacuum in the Vulcanization of Tires:

1—assembly of the innerlop—the vacuum is used to remove air from the interior of the envelope for the purpose of finding possible leaks and in this case it acts mainly as a linking and sealing element of the envelope after it is assembled, since the air removed from the two envelopes through the application of vacuum creates a system that affixes and seals through a rubber seal the inner envelope, thus keeping same joined and compressed on the tire until it is installed inside the autoclave for the vulcanization.
2—checking the sealing of the assembly elements before they are placed inside the autoclave, the main function of which is to check the envelope to detect any puncture or damage on its structure that may compromise the application of pressure to the tire, what is done as soon as the tire is assembled irrespective of the fact whether the assembly involves wheel, sealing ring or innerlop.
3—application of vacuum to the tire installed inside the autoclave the function of which is to help to draw any air present between the tire and the envelope as an optional air discharge pipe in the envelope with the use of a vacuum pump. There are two main uses of this system:
1—In some processes wherein, due to the nipple, the material applied thereto or any assembly item that makes it difficult for the air to pass from the interior of the envelope to the atmosphere out of the autoclave, vacuum is used to force the air to leave the envelope while the autoclave is inflated as a way to prevent any amount of air from being trapped between the envelope and the tire thus compromising the application of pressure to the tire.
2—In some processes vacuum is used during the vulcanization process to save tires that, although during the assembly thereof the envelope has been tested and approved, in the vulcanization there is a small leak that can be compensated for through the application of vacuum in order not to compromise the pressure applied on the tire; so that the vacuum helps to keep the pressure of the envelope on the tire, thus drawing the air.

We state again that any process of vulcanization in an existing autoclave depends mainly on the application of pressure to the tire in order to have a successful vulcanization, except in the case of the innerlop where the vacuum is applied after the assembly for joining both the inner and outer envelopes, the other procedures being optional and not used in all processes; when the sealing is checked, the most commonly way used is to check for air leaks through the air of the hose connected to the envelope escaping out of the machine continuously during the process of pressurization the machine that will show that the tire thus connected presents some sealing defect in an element of its assembly, thus forcing the operator to halt the operation, remove the tire from the machine and eliminate the leak.

### Installation of the Tire in the Autoclave

During the installation of the tire previously assembled with the housing inside the autoclave this housing provided with a nipple is connected to a hose and connected with the atmosphere outside the autoclave, thus creating two atmospheres of different pressures, that is, the outer area of the housing that contacts the pressure inside the autoclave and the inner area of the housing where the tire is located that is connected by the hose to the atmosphere outside the machine.

In the case of tires assembled with wheels, due to the fact that the air tube is assembled inside the tire, pressurization is required through another inner hose coupled to the autoclave connected to an outer pressure source that will inflate the air tube through the nipple to a higher pressure than the one inside the autoclave so that a pressure can be attained on the wheel that will help in the sealing of the envelope during the vulcanization.

### Pressurization of the Autoclave

After the tires have been previously assembled in the autoclave, it is closed in order to insulate the tires from the atmosphere outside the machine. Once the machine is closed, the atmosphere inside the autoclave is inflated to a preset pressure; in the event the tire is assembled with a wheel it is always required to raise the pressure of the air tube to a higher pressure than that of the autoclave for the purpose of assuring the sealing of the envelope that depends on the pressure at the edges of the wheel for assuring the sealing.

### Generation of Pressure in the Tire

With the autoclave inflated, a pressure between the interior thereof and the outer face of the envelope is generated, wherein the inner face of which containing the tire is sealed and connected to the atmosphere outside the machine as the pressure inside the autoclave increases, thus creating a differential pressure between the two faces of the envelope, the pressure on outer face of the housing being higher than the one inside the autoclave and thus exerting a compression of said housing against the tire, forcing the air present between the tire and the inner face of the envelope that does not have any pressure and is connected with the outer pressure to be expelled out of the machine through the nipple, thus compressing the envelope against the tire.

The compression of the tire exerted by the envelope under the action of the pressure of the autoclave will consequently compress the pre-molded rubber and the linking rubber applied to the tire, thus helping the adhesion process during the vulcanization of the tire.

### Temperature Parameters Applied in the Vulcanization of Tires

During the tire manufacturing process a temperature that reaches 175° C. for the vulcanization of the tire is usually used.

When tires are retreaded with the application of camelback in vulcanization presses using molds to apply the profile in the tire, the working temperature is about 150° C.

When tires are retreaded with the application of pre-molded rubber in autoclaves, the temperatures may range from 95° to 135° C.; in most the cases it is not higher than 115° C.

Most of the processes use linking rubbers that start vulcanizing at 95° C. and the autoclaves apply temperatures that range between 95° and 115° C. to carry out the vulcanization of the linking film that joins the pre-molded rubber to the tire; in the case of higher temperatures the procedure is to use the same material, however with a shorter vulcanization time in view of a higher temperature ratio.

Said film has usually a standard thickness ranging from 0.8 to 1.2 mm in most of the worldwide applications, therefore the amount of material to be vulcanized in the tire is quite small in relation to the whole structure of the tire or even the pre-molded rubber.

One of the leading pioneering worldwide companies in the process of application of pre-molded rubber in this type of process discloses its process as a cold retreading process for vulcanizing tires at temperatures always below 100° C., usually at a temperature of 95° C.

The company alleges that the application of a lower temperature helps in the preservation of the tires with a lower fatigue of the components thereof.

The application of temperatures within the range of about 100° C. really offers benefits for the carcass, and on the other hand creates a condition of a very high cost, since the rubber to be heated at this low temperature resists the passage of heat in view of the large thickness of the pre-molded rubber, thus forcing the tire to be under a continuous vulcanization process for up to 4 hours; a cycle time that is extremely high and long for a process. The purpose of our process of application of microwaves in the vulcanization is to correct this deficiency, since it allows to keep a temperature equal to or lower than that in the present process but drastically reduces the vulcanization time depending on the formularization of the rubber, since the heat transmission is not dependent on the thickness of the rubber and is generated locally on the base of the pre-molded rubber, thus providing large profits, productivity, energy, and ultimately less global production costs.

### Heating Systems in Autoclaves:

Any of the equipment applied in the two systems usually is provided with the most conventional heating sources, steam, electric resistance and thermal fluid.

### Ways of Using Heat in Autoclaves

Steam—can be applied directly to the tire or indirectly by heating coils or heating radiators installed inside the autoclave that heat the pressurized air inside the same.

Electric resistance—installed inside the machine, so that the heat it dissipates brings about the internal heating of pressurized air in the autoclave.

Thermal fluid—the thermal fluid transmits its heat through coils or heating radiators installed inside the machine that heat the pressurized air inside the same.

Retreading Process with Application of Conventional Pre-Molded Rubber:

It is basically comprised of 2 stages as follows:

1—preparation of the tire with the application of the pre-molded rubber.
2—vulcanization of the tire
1—The step of the tire preparation process consists of carrying out the following procedures:
1.1—Examination of the tire—wherein the tire is firstly cleaned and then checked for defects where the tires not in conditions of use are separated and discarded.
1.2—Scraping of the tire—wherein the tread layer of the tire with the profile of the tire has been removed and the surface has been cleaned and texturized for the application of new materials.
1.3—Preparation of repairs—wherein any damage inside or outside the carcass is cleaned and prepared for the application of rubber and repairs with patches, it is an optional procedure that depends on the conditions of the carcass that is carried out in the event of specific need of the tire.
1.4—Application of glue—wherein a layer of a rubber solution is applied for the purpose of adhering the linking rubber to the tire; this process may not exist, since in some cases where hot linking rubber is applied directly to the carcass through appropriate extruders the application of glue is not required.
1.5—Application of the linking rubber to the carcass, in many cases this procedure is not carried out, since there are manufacturers who sell the linking rubber applied directly to the pre-molded rubber, or the retreading expert applies the linking rubber previously to the pre-molded rubber ply and anticipates the storage in the process as a way to avoid this step during the process, thus speeding up the tire preparation time. As we commented in the previous step, it can be hot or cold applied together with the application of glue.
1.6—Application of the pre-molded rubber to the tire
It can be applied with or without the linking rubber, in which case it is applied directly to the carcass.
2—The steps of the tire vulcanization process consist of carrying out the following procedures:
2.1—application of the envelope to the tire
2.2—assembly of the tire, determining the assembly procedure according to the type of tire to vulcanize, that is:

Tire of diagonal construction in view of the fact that the plies are made of materials such as nylon, rayon, or polyester, it is required to assemble the tire with the wheel, since such materials, when heated without suitably tensioning the plies by the pressure in the air tube installed with the wheel, may present deformations in their structure and conformation, with undesirable ulterior retraction and stress in the final product, causing possible defects.

Tire of radial construction in view of the fact that the plies are made of steel, the assembly with the wheel is optional, and processes like those using sealing rings or innerlop may be used.

2.3—The leak test with the application of vacuum to the assembled tire, as already commented previously is an optional procedure
2.4—installation of the tire in the autoclave:
2.4.1—place the tire inside the autoclave.
2.4.2—couple the hose of the envelope air outlet.
2.4.3.—couple the air hose of the air bag in the event the tire is optionally assembled with air tube and wheel.
2.4.4—shut the autoclave door.
2.4.5—activate the electronic panel activate the pressure, time and temperature controls to vulcanize the tire, and if required open and close the manual valves not subject to automation.
2.4.6—Sealing test—after the initialization process of the panel soon after the pressurization of the autoclave, it is necessary to verify if there are any leaks in the envelope, since if they occur before starting heating the autoclave it is necessary to turn off the machines without removing the leaking tire and then restart the autoclave.
2.4.6—Vulcanization of the tire it takes place through the application of controlled time, pressure and temperature programmed according to the vulcanization curve of the linking rubber and dimension of the pre-molded rubber applied.
2.4.7—finishing the vulcanization cycle by depressurizing the vulcanization atmospheres and turning off the machine, the tire is removed from the autoclave by removing the hose and directing same to disassemble the tire.
2.4.7—disassembly of the tire by removing the sealing components.
2.5—verification of defects and possible final finishing of the tire.
2.6—Directing to storage or delivering at the customer's.

### SUMMARY OF INVENTION

The present patent is directed to a heating process through microwaves and the use of conductive materials in a pre-molded rubber using one or more layers of rubber formulations the function of which is to preserve the development of products established in the market applied to the tread of wheels in the area of the profile that solve specific questions of application in the market without compromising the effective functioning of the project, that only requires conductivity at the base of the pre-molded rubber that is the area that contacts the linking rubber in order to vulcanize same.

The use of a material that is subjected to microwaves only at the base fulfills the need in the market for the development of a product, and provides reduced producing cost on the final product as well.

The object of the present invention is to provide a vulcanization process of rubber tires with the uses of microwave which comprises the following steps:

1—development of material—it is a process including the addition of conductive materials to formulations of pre-molded rubber in its full or partial structure specifically in the layer of the base, for retreading tires through microwave heating, where the temperature to be reached by the vulcanization is equalized as a function of the vulcanization curve of the linking rubber applied to the tire. The control of the addition process will cause a heating of the pre-molded rubber under certain parameters in view of the adequacy of the type and content of carbon black and other semi-conductive materials, the requirements regarding the type of construction of the tire, the rubber structure and formulation in the tread required for the several applications that the tire is submitted to being complied with; making it possible for the microwaves to act within a range with a high heating efficiency index; thus attaining the desired temperature in a shorter fraction of time for carrying out the vulcanization process successfully.
2—processing of the material—wherein the vulcanization process of pre-molded rubber having semi-conductive properties subjected to microwave heating comprises the following steps:
a—preparation of the tire: a1.—examination of the tire; a2.—scraping of the tire; a3.—preparation of the repair (in the event it is required); a4.—application of glue; a5.—application of linking rubber to the carcass (optional) applied to the pre-molded rubber; and a6.—application of pre-molded rubber with semi-conductive properties to the tire subjected to microwave heating in an autoclave for the purpose of vulcanizing the linking rubber that joins this material to the tire.
b.—vulcanization of the tire: b1.—assembly of the tire with a wheel, sealing ring or innerlop by optionally applying vacuum to check for sealing defects; b2.—installation of the tire in the autoclave by attaching same to rotary cradles and connection of the envelope hoses and the air bag in the event it is assembled with the wheel; b3.—closing of the door of the autoclave; b4.—activation of the electronic panel for controlling the time, pressure and temperature in order to initialize the vulcanization process; b5.—after the autoclave is pressurized, checking for possible leaks in the envelopes; b6.—application of microwaves to the tire and heating of the pre-molded rubber through a microwave generating device with specifications in accordance with the dimensions of the tire, the rubber to be vulcanized having enough frequency parameters to fulfill the needs of the formulation of the product, possible repairs in the device as well as the assembling method used; and b7.—the adequate transmission of heat from the base of the pre-molded rubber for vulcanizing the linking rubber using temperature and time in accordance with the vulcanization curve of the linking rubber and the applied materials, preferentially opting for the minimum temperature range required by the materials for carrying out the process successfully.

### DESCRIPTION OF THE FIGURES

FIG. 1 shows a detailed schematic view of the parts that compose the tire in the process of vulcanization of rubber tires through the use of microwaves.

FIG. 2 is a schematic view of a tire vulcanization autoclave.

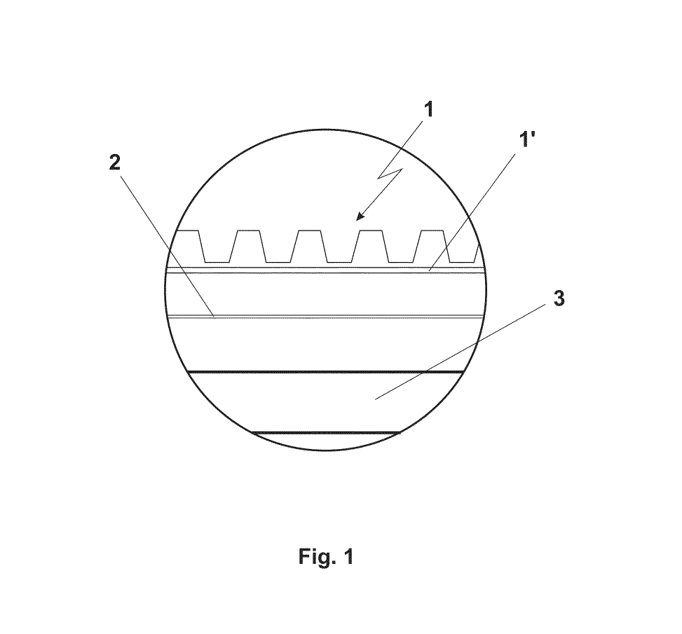

### DESCRIPTION OF FIG. 1

1—Premolded rubber
1′—Base premolded rubber
2—Connection rubber
3—Tire

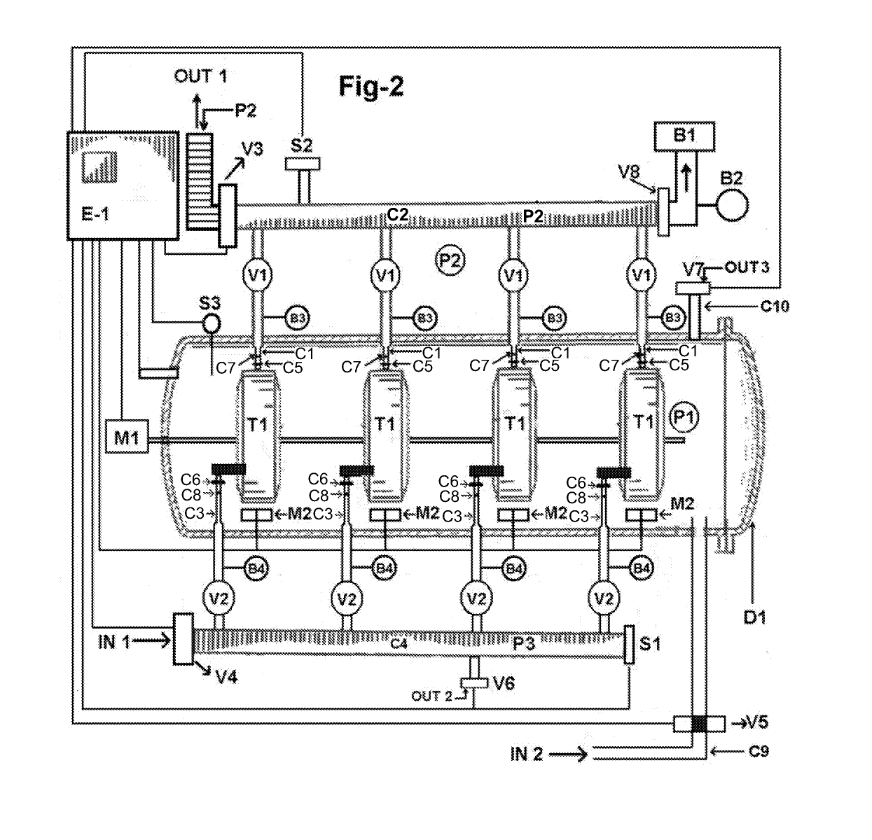

### DESCRIPTION OF FIG. 2

Components of the Air Discharge Pipe and Vacuum Application on Envelopes.
V1—Single air discharge valve.
V3—General air discharge valve.
V8—Air intake valve of the vacuum pump.
B1—Vacuum pump.
B2—Vacuum meter.
S2—Pressure gauge.
B3—Single manometer.
C2—Envelope air discharge pipe
OUT1—General air discharge pipe.
C1—Air discharge or vacuum application hose.
C5—Envelope nipple.
C7—Hose coupling to the envelope nipple.

Components of the Air Intake Pipe for Pressurization of the Air Bag of Tires Assembled with Wheels.
V2—Single air intake valve.
V4—General air intake valve.
V6—Air discharge valve.
S1—Pressure gauge.
B4—Air bag manometer.
IN1—Compressed air intake pipe.
OUT2—Compressed air discharge pipe.
C3—Air bag inflating hose.
C4—Air bag pipe.
C6—Air tube nipple.
C8—Hook of the hose of the air bag.

Components of the Air Intake Pipe for Pressurization of the Autoclave
V5—Air intake valve.
V7—Air discharge valve.
S3—Pressure gauge.
In2—Compressed air intake pipe.
OUT3—Compressed air discharge pipe.
C9—Air intake pipe of the autoclave.
C10—Air discharge pipe of the autoclave.

Components of the Autoclave
D1—Autoclave door.
E1—Electronic control panel of the autoclave.
M1—Rotary cradle of tires.
T1—Tires assembled inside the autoclave.
M2—Microwave generators.

Pressure Inside the Autoclave:
P1—Pressure of the autoclave inner area.
P2—External atmosphere pressure internally connected inside the autoclave by coupling the hose to the nipple of the envelope, thus creating an atmosphere out of the autoclave inside the sealed envelope the tire is contained in.
P3—Pressure of the air bag assembled inside the tire assembled with wheel.

### DETAILED DESCRIPTION OF THE INVENTION

The vulcanization process of tires of the present invention, is based on the application of a premolded profile in an autoclave but, differently from the vulcanization processes of the state of the technique, the elastomer is subject to the effect of microwaves.

For the purpose of this invention, the following terms and concepts are defined:

Heat: the heat (abbreviated as Ft) is the thermal energy transferred between two bodies at different temperatures. The heat is an energy that is transferred from a system to another, without mass transport, and that does not correspond to the execution of a mechanical work, thus there is no sense in saying that a body has more heat than other. The unit in the International System (IS) for heat is joule (J).
Heat generation: any body has defined quantity of internal energy that is related to the random movement of its atoms and molecules. This internal energy is directly proportional to its temperature. When two bodies or fluids in different temperatures interact (by contact or radiation), they change internal energy until the temperatures are the same. The amount of transferred energy is the amount of changed heat, if the system is isolated from other ways of energy transfer.

The Processes of Heat Transfer are:

(1) Thermal conduction: it is a way of heat transfer that generally happens in solid materials, due to the heat propagation through the contact of molecules of two or more substances with different temperatures (metal, wood, ceramic, etc.).

In fluid (liquid and gas) materials the heat transfer through conduction also happens. However, in these materials the increase in temperature changes the density of the fluid in the hottest part, provoking a macroscopic movement. This displacement, which happens from the part of the hottest fluid to the coldest one, increases the speed of transport of thermal energy. This phenomenon is called convection.

(2) Convection phenomenon: it is a process of mass transportation due to the pulling of a solute by a moving solvent. The term can also be applied in heat transfer when there is a global movement and blend of macroscopic elements to different temperatures or the energy change between a fluid and a solid surface. The mass transport due to density differences is called free or natural convection; if there is a mechanically forced movement, for example, by a pump or fan, the process is called forced convection.
(3) Radiation or irradiation: it is a form of heat transfer through electromagnetic waves, where two bodies in different temperatures tend to the thermal balance, even if between them there is no material atmosphere. For example, the sun warming up the earth, where there is a vacuum between them.
(4) Microwaves: also called SHF (Super High Frequency), they are electromagnetic waves with larger wavelengths than the ones of the infrared rays, but smaller than the wavelength of the radio waves varying from 30 cm (1 GHz of frequency) to 1 cm (30 GHz of frequency). To the waves above 300 GHz, the absorption of the electromagnetic radiation by the earth atmosphere is so high that the atmosphere is practically opaque to the highest frequencies, until it turns again transparent in the also called infrared window up to the visible light.

Action of the microwaves: the materials react differently to the energy produced by the microwaves. In this sense they are classified as: conductive, insulating and dielectric, as better described below:

(1) Conductive materials: they are basically formed by metals. When they receive the impact of microwaves, they reflect them, just as a mirror reflects the light. Thus, for the conductive materials the microwaves do not penetrate and do not heat them.
(2) Insulating materials: in this case the transmission of microwaves happens, however with little effect or even no heating effect, similarly to the passage of the light through a glass.
(3) Dielectric materials: they represent the great majority of the materials, having intermediate properties between the insulating and the conductive materials. The microwaves penetrate the materials as to the insulating ones but unlike these, they absorb energy, where this absorption results in a heating of the dielectric material.

Heating of an elastomer by microwaves: the rubber is a dielectric material and thus it can be heated by microwaves, being its heating associated to its molecular structure. Technically the rubber molecule is called “polar”.

Thus when an elastomer is submitted to a strong microwave field, its molecules tend to be orientated in accordance with the electric field. The direction of the electric field then continually varies in fraction of seconds, which provokes an angular loss by friction and, as a consequence, the elastomer heating.

In order to obtain an efficient heating the materials should necessarily present a certain polarity. The elastomers used in the tires production are predominantly physical blends of natural rubber (NR) and butadiene-styrene (SBR) copolymer or also of NR and polybutadiene (BR).

Also in the scope of elastomer formulation applied to tires, the organic charge, especially the carbon black, is characterized by being a “semi-conductive” material. This physical condition makes the elastomer progressively loses the dielectric capacity when mixed with the polymeric materials.

Thus it is conclusive that the choice of the type and quantity of organic charge determines the possible adjustment of loss of dielectric capacity at a desired level. This condition happens due to the size of the particle of organic charge (carbon black).

This condition can be best understood knowing that the organic charge of carbon black, when below a certain content, presents small particles, such as the “ISAF”- and “HAF”-type charges, which warm up in a faster way than the observed to “FEF- and “SRF”-type charges. The carbon black structure also influences the heating. The carbon black of low structure warms up faster than the one of high structure. Thus the increasing of the carbon black content increases the heat generation.

Use of white charges: they are usually insulating compounds and therefore the loss factor is low. In other words, the heat generated when the rubber is charged with kaolin-type or carbonate of calcium charges, the heating result is lower. For compounds charged with white charges, to reach a heating comparable to the heating obtained with carbon black it is necessary to add precipitated silica, due the size of its particles and its specific polarity.

However, the NR and SBR or BR rubbers are non-polar polymers, practically presenting no interaction with microwaves.

To avoid this limitation, meaning to make these rubbers react when exposed to microwaves, “electricity conductive charges” are used, especially carbon black.

The increase in the content of carbon black and other filler, as well as components having a polar characteristic, will affect the viscoelastic properties of the rubber to be examined for any tire application so that it is consonant with the formulation in order to attain a satisfactory performance of the product.

From the technical point of view the introduction of electricity conductive charges promotes a phenomenon known as “Maxwell-Wagner polarization”, which is translated by the heating of the tire rubber, since it presents a relatively high amount of this charge type (usually carbon black).

The inedited vulcanization process of tires, with the application of premolded profiles in autoclave with heating by microwaves, of the present invention, is characterized by being of physical nature, meaning, it does not need the use of chemical reagents. This condition allows the application of high amount of energy in the artifact, and also for a short period of time, making viable a high productivity with corresponding reduction of energy consumption, leading to a reduction of industrial costs, and generating a scale effect.

The vulcanization process of the present invention has the following steps:

1. analysis of the connection rubber (2) to be vulcanized, to determine the ideal vulcanization temperature that may range between 75 and 135° C.;
2. analysis of the premolded rubber (1) of the tread to determine the temperature of the base (1′) as a function of microwave frequency ranges applied to determine the relation between the frequency and the heating temperature of the base (1′);
3. adequacy of the formulation of the pre-molded rubber (1), specifically the base (1′) for the purpose of equalizing the temperature of the base of the pre-molded rubber (1) with the temperature of the linking rubber (2) to be vulcanized through the addition of 1-40% half-conductive loads in the composition of the base (1′) of the pre-molded rubber (1), that is made into two layers, the profile layer keeping the characteristics of the original formulation of the product and only the base (1′) with a formulation adapted for reaching the desired heating, without changing the original dimensions of the product and the two layers joined together before the pre-molded rubber (1) is vulcanized.
4. preparation of the tire (3) through the following steps:

4,1—examination of the tire (3);

4,2—scraping of the tire (3);

4,3—preparation of possible repairs;

4,4—application of the linking rubber (2) and the pre-molded rubber (1), already adjusted through the addition of the semi-conductive material to the tire (3) by using a glue;
5. assembly of the tire prepared for vulcanization with the application of the envelope and sealing systems that may be through the use of wheel, sealing ring or inner envelope;
6. installation of the tire assembled inside the autoclave in a rotary device and installation of envelope hoses and air bag when the assembly involves a wheel;
7. application of microwaves to heat the base (1′) of the pre-molded rubber (1) at the required temperature to vulcanize the linking rubber (2); determined in accordance with the specification of the temperatures set out in items 1, 2, and 3. The time of application of microwaves to heat the base (1′) is a function of the dimensions of the pre-molded rubber (1), and may range between 10 minutes and 120 minutes.

The semi-conductive loads used in the process could belong to the group that consists of:

Black fillers: Carbon Black and several classifications thereof;

White fillers: Calcium carbonate, Barite, Magnesium carbonate, Litopone, Kaolin, Regular zinc oxide, Fine particulate zinc oxide, Precipitated calcium silicate, Precipited silica, Progenic silica;

Plastifiers: Dop, Dbp, Parafinic, naphthenic, or aromatic oils;

Other additives: DEG, PEG, Graphite.

Any polar product of the formulation that may increase the electric conductivity and have the key characteristic of being “POLAR.”

The vulcanization of the tire involves the physical transformation of the rubber where the base (1′) of the pre-molded rubber (1) has a higher concentration of carbon black than the other rubber components, in view of its high polarity indices, allowing a faster heating in relation to the other components of the structure of the tire, wherein said thermal condition will generate the required heat in the base (1′) of the pre-molded rubber (1) to vulcanize the linking rubber that will require a little time for the vulcanization to take place, due to its small thickness of no more than 1,2 mm.

As a complement to provide a better homogeneity in the heat distribution over the rubber previously charged inside the autoclave, the autoclaves have rotating cradles in its interior, where the tires are placed.

This condition aggregates advantages from the point of view of durability of the vulcanized tire, due to the increased life of the airbag. During the autoclave operation with microwaves it is determined that there is less exposition to lower heating temperatures, this condition reflecting on the tire carcass, which receives a smaller thermal aggression.

Additionally, and as determinant factor of differentiation, when compared to the vulcanization process in traditional autoclave, there is an expressive reduction of vulcanization time, since the microwaves technology is characterized by the speed of obtaining the heating up to the desired temperature.

The viability of the above process requires the use of a special equipment, which can be an adaptation of an autoclave (with all resources of pressure, temperature and time controls) with an adapted microwaves generating device. Such equipment should have a specification in accordance with the dimensions of the rubber tire to be vulcanized, as well as it should consider the heating needs and possibilities of a process of this nature in an uniform and controlled way. Particularly, on order to obtain a homogeneous heating of the tires to be vulcanized, the equipment should have several rotating cradles in its interior to accommodate the rubber tires previously prepared for vulcanization.

Also, the control of the frequency parameters, vulcanization temperature and cure time is also determined by the type and quality of the elastomeric raw material, such as: thickness; width; rubber formulation; repairs in the artifact; assembly methods, and artifact size.

1. A vulcanization process for a rubber tire with the use of microwave frequencies, the process comprising the steps of:
(1) providing a connection rubber layer (2);
(2) analyzing the connection rubber layer and determining an ideal vulcanization temperature for the connection rubber layer within a range varying from 75 to 135° C.;
(3) providing a premolded vulcanized rubber (1), having a base (1′);
(4) analyzing the premolded vulcanized rubber and determining a temperature for heating the base, based on microwave frequencies band applied for determining the relation between the microwave frequencies and the temperature for heating the base;
(5) providing a composition of the base for equalizing the temperature of the base with the temperature of the connection rubber layer (2), by adding semi-conductive charges within a range varying from 1-40%, providing for a higher heating differential in the base than to the other components of the tire;
(6) preparing the tire, the tire having an internal and an external surface, the preparation comprising:
(6a) examining the tire;
(6b) scratching the external surface of the tire;
(6c) repairing the tire, if necessary;
(6d) applying the connection rubber layer and the premolded vulcanized rubber with the added semi-conductive charges over the tire, using a glue;
(7) assembling the prepared tire by applying an envelope and a sealing system, the sealing system selected from the group consisting of: stub, sealing ring or internal envelope;
(8) accommodating the assembled tire on a rotating cradle inside an autoclave;
(9) installing envelope hoses and airbag hoses, when the tire is assembled on a stub, and
(10) applying microwaves over the tire for heating the base to the ideal predetermined temperature sufficient for vulcanizing the connection rubber layer, according to steps (1) to (4).

2. The vulcanization process for a rubber tire, according to claim 1, wherein the semi-conductive charges are selected from the group consisting of: black fillers, white fillers, plastifiers, DEG, PEG and graphite.

3. The vulcanization process for a rubber tire, according to claim 2, wherein the black fillers are carbon black within the several classifications thereof.

4. The vulcanization process for a rubber tire, according to claim 2, wherein the white fillers are selected from the group consisting of: calcium carbonate, barite, magnesium carbonate, litopone, kaolin, regular zinc oxide, fine particulate zinc oxide, precipitated calcium silicate, precipited silica and progenic silica.

5. The vulcanization process for a rubber tire, according to claim 2, wherein the plastifiers are selected from the group consisting of: Dop, Dbp, Parafinic, naphthenic and aromatic oils.
